(19) United States
(12) Patent Application Publication
(10) Pub. No.: US 2008/0225178 A1
(43) Pub. Date: Sep. 18, 2008

(54) AUTOMATIC SIGNAL GAIN CONTROL METHOD AND APPARATUS

(75) Inventors: Deuk-geun AHN, Anyang-si (KR); Kyoung-hwan Kim, Suwon-si (KR); Sang-min Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/830,021

(22) Filed: Jul. 30, 2007

(30) Foreign Application Priority Data
Mar. 16, 2007 (KR) 10-2007-0026271

(51) Int. Cl. H04N 5/08; H04L 27/08

(52) U.S. Cl. 348/678; 348/532; 375/345; 348/E05.009; 348/E05.115; 348/E05.036; 348/E05.041

(57) ABSTRACT

Provided are an automatic signal gain control method and apparatus that adaptively controls signal gain according to sync tip depths in a video receiving system. The method includes: detecting a sync signal from a video signal; detecting a blank level and a sync tip level from a sync section of the sync signal; extracting a difference between the blank level and the sync tip level, as a sync tip depth; and controlling the gain of the video signal differently according to a variation of the sync tip depth.

### CROSS-REFERENCE TO RELATED PATENT APPLICATION

This application claims priority from Korean Patent Application No. 10-2007-0026271, filed on Mar. 16, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to video reception, and more particularly, to automatic signal gain control in which signal gain is adaptively controlled according to sync tip depths.

2. Description of the Related Art

Generally, an automatic gain controller (AGC) detects amplitude variations of an input signal and automatically controls the gain of the input signal in order to maintain an output signal at a constant amplitude.

FIG. 1 shows waveforms of video signals for explaining the operation of a related art AGC. As shown in portion (a), a video region is divided into an active video region 111 and a sync tip region 112. The sync tip region 112 includes a blank level 120 and a sync tip level 110. In the National Television Standards Committee (NTSC) system, the standard level of the active video region 110 is 100 IRE (the Institute of Radio Engineers), and the standard level of the sync tip region 112 is 40 IRE.

As shown in portion (b), an active video region 111 has a standard level of 100 IRE, whereas the level of a sync tip depth 110-1 is lower than the standard level. Thus, it is necessary to increase the level of the sync tip depth to the standard level of the sync tip region 112. If the level of the sync tip depth is lower than the standard level, the related art AGC needs to increase the level of the active video region in order to maintain the sync tip depth at a normal level.

However, if the level of the active video region increases, a color signal of the active video region is saturated, as indicated by the circled area 140. Therefore, the related art AGC, which increases the level of the active video region so as to maintain a normal level of the sync tip depth, has lost a part 140 of the color signal of the active video region that exceeds the standard level 130 of the active video region.

### SUMMARY OF THE INVENTION

The present invention provides an automatic signal gain control method that adaptively controls signal gain using non-linear gain characteristics according to variation sections of a sync tip depth in a video receiving system.

The present invention also provides an automatic signal gain control apparatus to which an automatic signal gain control method is applied.

According to an aspect of the present invention, there is provided an automatic signal gain control method, comprising: detecting a sync signal from a video signal; detecting a blank level and a sync tip level from a sync section of the sync signal; extracting a difference between the blank level and the sync tip level, as a sync tip depth; and controlling the gain of an input video signal differently according to variations of the sync tip depth.

According to another aspect of the present invention, there is provided an automatic signal gain control apparatus, comprising: a low pass filter (LPF) detecting a sync signal from a video signal; a blank level detector detecting a blank level from the sync signal detected by the LPF; a sync tip detector detecting a sync tip level from the sync signal detected by the LPF; a sync tip depth extractor extracting a difference between the blank level detected by the blank level detector and the sync tip level detected by the sync tip detector, as a sync tip depth; and an adaptive gain controller controlling the gain of an input signal by selectively using non-linear gain characteristics and linear gain characteristics according to the sync tip depth extracted by the sync tip depth extractor.

### BRIEF DESCRIPTION OF THE DRAWINGS

The above and other aspects of the present invention will become more apparent by describing in detail exemplary embodiments thereof with reference to the attached drawings in which:

FIGS. 1A and 1B show waveforms of video signals for explaining the operation of a related art automatic gain controller (AGC);

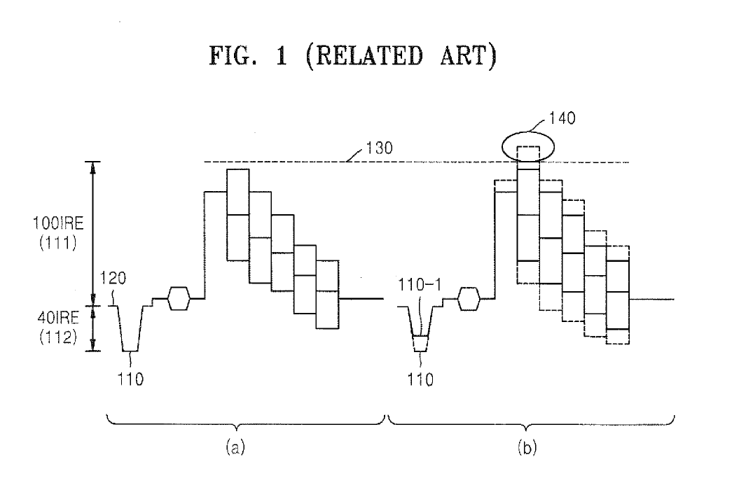

FIG. 2 is a block diagram of an automatic signal gain control apparatus according to an exemplary embodiment of the present invention;

FIG. 3 is a block diagram of an adaptive gain controller illustrated in FIG. 2, according to an exemplary embodiment of the present invention;

FIG. 4 is a graph of the gain characteristics of the adaptive gain controller according to an exemplary embodiment of the present invention;

FIG. 5 is a graph of the gain characteristics of the adaptive gain controller according to another exemplary embodiment of the present invention;

FIG. 6 is a flowchart of an automatic signal gain control method according to an exemplary embodiment of the present invention; and

FIGS. 7A through 7C are graphs of gain characteristics stored in a look-up table according to an exemplary embodiment of the present invention.

### DETAILED DESCRIPTION OF EXEMPLARY EMBODIMENTS

Exemplary embodiments of the present invention will now be described in detail with reference to the accompanying drawings.

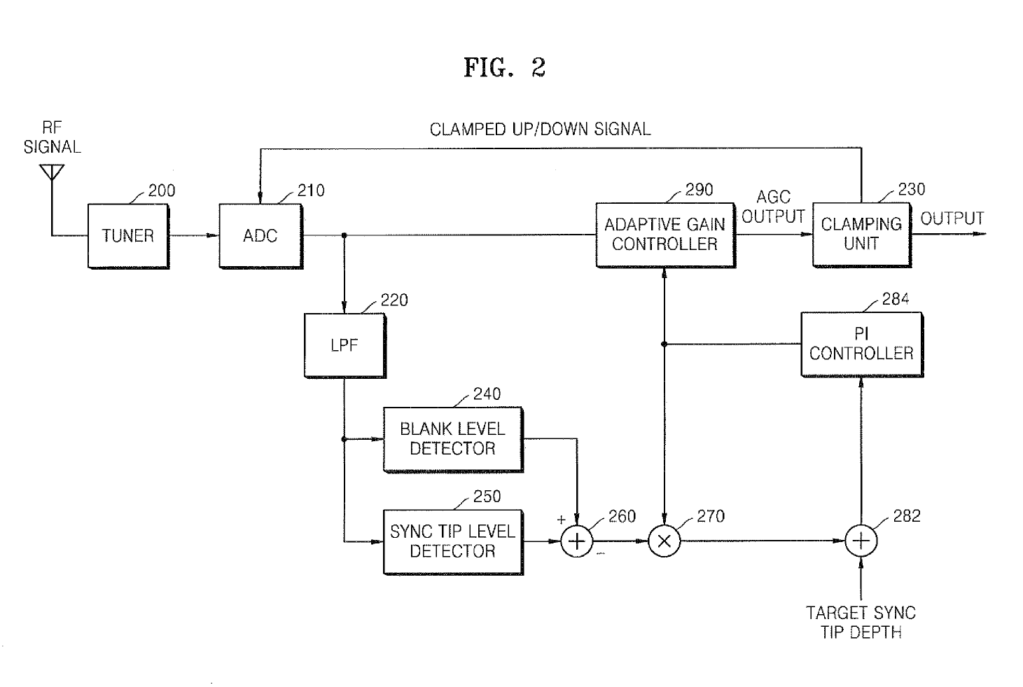

FIG. 2 is a block diagram of an automatic signal gain control apparatus according to an exemplary embodiment of the present invention. Referring to FIG. 2, the automatic signal gain control apparatus comprises a tuner 200, an analog-digital converter (ADC) 210, a low pass filter (LPF) 220, a clamping unit 230, a blank level detector 240, a sync tip level detector 250, a sync tip depth extractor 260, a multiplication unit 270, an adding unit 282, a proportional integrated (PI) controller 284, and an adaptive gain controller 290.

The tuner 200 down-mixes a television (TV) radio frequency (RF) signal of a public wave through an antenna into a base band video signal. The video signal is a composite signal including a luminance signal and a chroma signal.

The ADC 210 converts the base band video signal into a digital video signal, and outputs the digital video signal according to a clamped up/down signal of the clamping unit 230.

The LPF 220 removes a high frequency component from the output video signal of the ADC 210. The video signal is clamped in a blank level that is an intermediate level between the level 100 IRE of an active video region and a sync tip level of 40 IRE.

The blank level detector 240 detects the blank level from the clamped video signal. For example, the blank level can be detected using a sample value of a blank signal.

The sync tip level detector 250 detects a sync tip level that is the lowest below the blank level from the clamped video signal. For example, the sync tip level can be detected using a sample value of a sync signal.

The sync tip depth extractor 260 extracts a sync tip depth as a difference between the blank level detected by the blank level detector 240 and the sync tip level detected by the sync tip level detector 250.

The multiplication unit 270 multiplies the sync tip depth value extracted from the sync tip depth extractor 260 by an output sync tip depth value of the PI controller 284.

The adding unit 282 adds a target sync tip depth value to the output sync tip depth value of the multiplication unit 270.

At this time, the target sync tip depth value is defined by a user.

The PI controller 284 gradually varies the size of a sync tip by accumulating the output sync tip depth value of the adding unit 282 in proportion to the output sync tip depth value.

The adaptive gain controller 290 adaptively controls the gain of the video signal by selectively using the non-linear gain characteristics and linear gain characteristics of the sync tip depth, according to the output sync tip depth values of the PI controller 284, and outputs a final AGC signal. The user can change the non-linear gain characteristics and linear gain characteristics of the sync tip depth to optimum values.

For example, if the sync tip depth is within a predetermined sync tip error range, the adaptive gain controller 290 controls the gain of an input signal using the non-linear gain characteristics, and, if the sync tip depth is outside the predetermined sync tip error range, the adaptive gain controller 290 controls the gain of the input signal using the linear gain characteristics.

As another example, the adaptive gain controller 290 can adaptively control the gain of the input signal according to the output sync tip depth value of the sync tip depth extractor 260.

As another example, sync tip depth values can be mapped to gain values and stored in a look-up table. The adaptive gain controller 290 stores the look-up table, extracts a gain value corresponding to a sync tip depth of an input video signal from the look-up table, multiplies the gain value by the input video signal, and automatically controls the gain of the input video signal.

The clamping unit 230 clamps the output video signal of the adaptive gain controller 290 in the blank level that is the intermediate level between the level 100 IRE of the active video region and the sync tip level of 40 IRE, and feeds back the clamped up/down signal to the ADC 210.

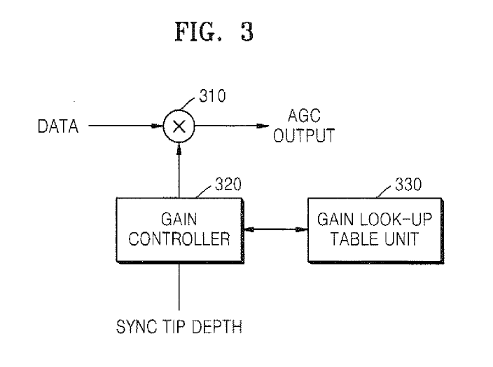

FIG. 3 is a block diagram of the adaptive gain controller 290 illustrated in FIG. 2. Referring to FIG. 3, the adaptive gain controller 290 comprises a multiplication unit 310, a gain controller 320, and a gain look-up table unit 330.

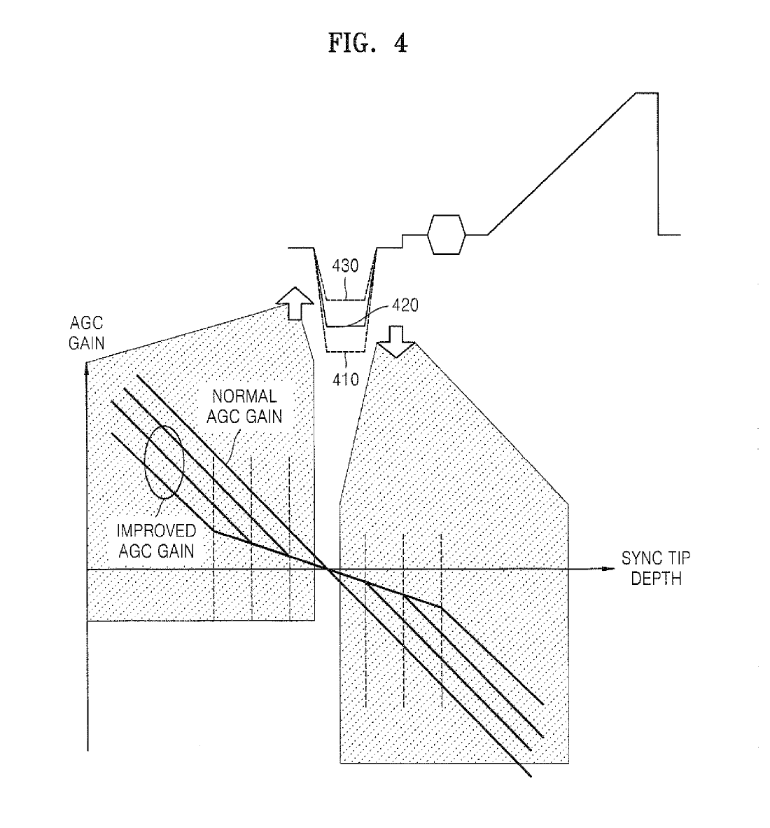

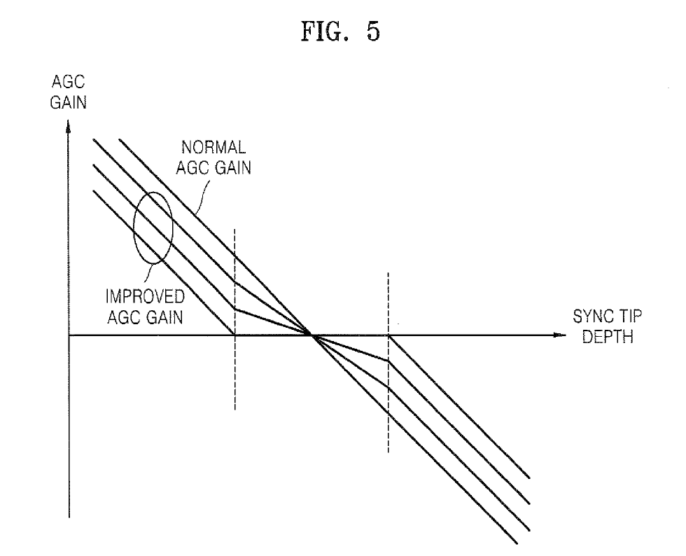

The gain look-up table unit 330 stores gain values having the linear and non-linear characteristics corresponding to a plurality of sync tip depth values in the look-up table. The linear and non-linear gain characteristics are illustrated in FIGS. 4 and 5.

The gain controller 320 extracts a gain value corresponding to an input sync tip depth value from the gain look-up table unit 330. The gain controller 320 compares the input sync tip depth with a predetermined sync tip error range to select the non-linear characteristics or the linear gain characteristics, and controls the gain characteristics of the gain look-up table unit 330 using a register.

The multiplication unit 310 multiplies the gain value corresponding to the output sync tip depth value of the gain controller 320 by sampled data from the ADC 210, and outputs ADC video data.

FIG. 4 is a graph of the gain characteristics of the adaptive gain controller 290 according to an exemplary embodiment of the present invention. Referring to FIG. 4, the adaptive gain controller 290 controls signal gain using improved non-linear AGC gains that are adapted to various sync tip depth levels 410, 420, and 430. In accordance with a user's request, the adaptive gain controller 290 can change sync tip depth sections (denoted by dotted lines in FIG. 4) in which signal gain variations are adaptive to the variations of the sync tip depth. For example, in a section showing a small variation of the sync tip depth, the adaptive gain controller 290 controls signal gain using the non-linear gain characteristics, and in a section showing a great variation of the sync tip depth, the adaptive gain controller 290 controls signal gain using the linear gain characteristics.

FIG. 5 is a graph of the gain characteristics of the adaptive gain controller 290 according to another exemplary embodiment of the present invention. Referring to FIG. 5, the adaptive gain controller 290 controls signal gain using the improved non-linear AGC gains that are adapted to variations of a sync tip depth. In accordance with a user's request, the adaptive gain controller 290 can change signal gains in sync tip depth sections (dotted lines). For example, the adaptive gain controller 290 can set an AGC gain to “1” in a variation section (e.g. between 95%-105% of a standard sync tip depth) of the sync tip depth indicated by dotted lines.

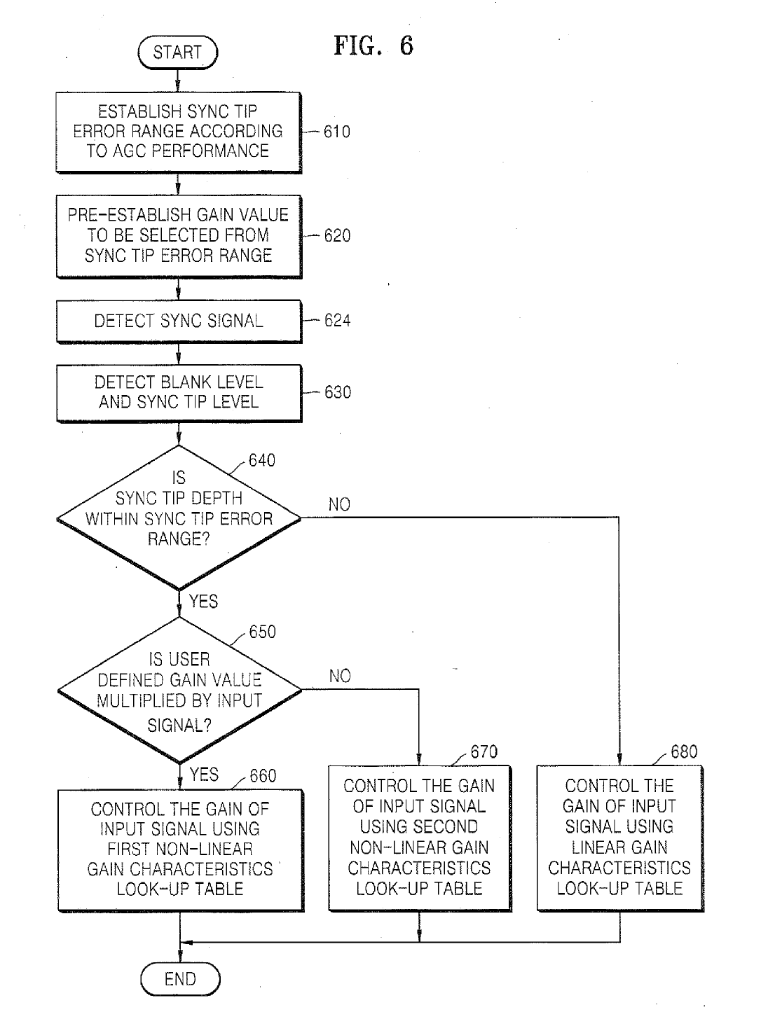

FIG. 6 is a flowchart of an automatic signal gain control method according to an exemplary embodiment of the present invention. Referring to FIG. 6, a software engineer or a TV set user establishes a sync tip error range (e.g. ±2%) according to the AGC performance (Operation 610), and pre-establishes a gain to be selected from the sync tip error range (Operation 620). The sync tip error range includes sync tip depth values that do not increase signal gains of an active video region, even when a sync tip changes.

A video signal is received to detect a sync signal (Operation 624).

A blank level and a sync tip level are detected from a sync section of the sync signal, and the difference between the blank level and the sync tip level is determined as the sync tip depth (Operation 630).

It is determined whether the sync tip depth is within the sync tip error range (Operation 640).

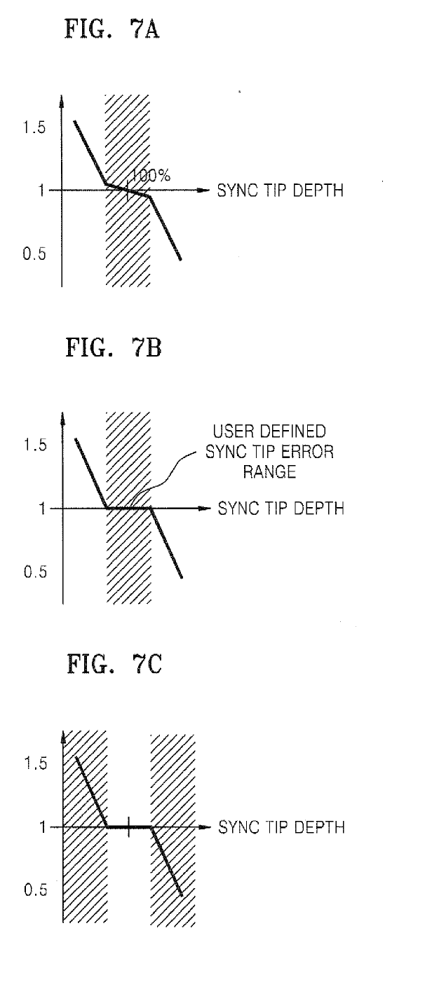

If it is determined that the sync tip depth is outside the sync tip error range (i.e. if the variation in sync tip size is greater than the sync tip error range), the gain of an input signal is controlled using a look-up table storing linear gain characteristics shown in FIG. 7C (Operation 680). Referring to FIG. 7C, two shaded areas are outside the user defined sync tip error range.

If the sync tip depth is within the sync tip error range, it is determined whether a user defined gain value is multiplied by the input signal within the sync tip error range (Operation 650).

If it is determined that the user defined gain value is multiplied to the input signal, the gain of the input signal is controlled using a non-linear gain value of a look-up table storing non-linear gain characteristics, shown in FIG. 7A (Operation 660). Referring to FIG. 7A, a shaded area is within the user defined sync tip error range. For example, gain values are controlled to “0.95-1.05” within the established sync tip error range.

If it is determined that the user defined gain value is not multiplied to the input signal, the gain of the input signal is controlled using a non-linear gain value of a look-up table storing non-linear gain characteristics shown in FIG. 7B (Operation 670). Referring to FIG. 7B, a shaded area is within the user defined sync tip error range. All gain values corresponding to sync tip depth values are “1” within the sync tip error range.

According to the present invention, different gain variations are established in sections depending on whether the sync tip depth varies greatly or slightly, in an AGC circuit that controls active video amplitude according to variations in a sync tip depth. The AGC is operated using non-linear gain characteristics in sections where the sync tip depth varies slightly, and using linear gain characteristics in sections where the sync tip depth varies greatly.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, the present invention selectively applies linear and non-linear gain characteristics to an AGC circuit according to variations in a sync tip depth, thereby reducing color saturation and signal clamping. In particular, when an active video region level is normal, but a sync tip depth level is slightly low, signal the gain is controlled non-linearly, thereby improving image quality. A user can also change the signal gain of the AGC circuit in each section of the sync tip depth.

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. An automatic signal gain control method comprising:
detecting a sync signal from a video signal;
detecting a blank level and a sync tip level from a sync section of the sync signal;
extracting a difference between the blank level and the sync tip level, as a sync tip depth; and
controlling the gain of the video signal differently according to a variation of the sync tip depth.

2. The method of claim 1, wherein the gain of the video signal is controlled by selectively using non-linear gain characteristics and linear gain characteristics according to the variation of the sync tip depth.

3. The method of claim 2, wherein a section with respect to the variation of the sync tip depth, where the non-linear gain characteristics are used, and the non-linear gain characteristics are set by a user.

4. The method of claim 3, wherein the gain is set to 1 within the section with respect to the variation of the sync tip depth, where the non-linear gain characteristics are used.

5. The method of claim 1, wherein if the sync tip depth is within a sync tip error range, the gain of the video signal is controlled using non-linear gain characteristics, and if the sync tip depth is outside the sync tip error range, the gain of the video signal is controlled using linear gain characteristics.

6. The method of claim 5, wherein the user determines a gain value to be used if the sync tip depth is within the sync tip error range.

7. The method of claim 1, wherein gain characteristics data is stored in a look-up table.

8. An automatic signal gain control apparatus comprising:
a low pass filter (LPF) which detects a sync signal from a video signal;
a blank level detector which detects a blank level from the sync signal;
a sync tip detector which detects a sync tip level from the sync signal;
a sync tip depth extractor which extracts a difference between the blank level and the sync tip level, as a sync tip depth; and
an adaptive gain controller which controls the gain of the video signal by according to a variation of the sync tip depth.

9. The apparatus of claim 7, wherein the adaptive gain controller comprises:
a gain look-up table unit which stores gain values corresponding to a plurality of sync tip depths;
a gain controller which controls a gain value corresponding to the sync tip depth of the video signal from the gain look-up table unit; and
a multiplication unit which multiples the gain value and the video signal.

10. The apparatus of claim 9, wherein the gain look-up table unit comprises non-linear and linear gain characteristics data.

11. The apparatus of claim 8, wherein the gain of the video signal is controlled by selectively using non-linear gain characteristics and linear gain characteristics according to the variation of the sync tip depth.

12. The apparatus of claim 11, wherein a section with respect to the variation of the sync tip depth, where the non-linear gain characteristics are used, and the non-linear gain characteristics are set by a user.

13. The apparatus of claim 12, wherein the gain is set to 1 within the section with respect to the variation of the sync tip depth, where the non-linear gain characteristics are used.

14. A computer readable recording medium storing a program for executing an automatic signal gain control method, the method comprising:
detecting a sync signal from a video signal;
detecting a blank level and a sync tip level from a sync section of the sync signal;
extracting a difference between the blank level and the sync tip level, as a sync tip depth; and
controlling the gain of the video signal differently according to a
variation of the sync tip depth.
